(19) United States
(12) Patent Application Publication
(10) Pub. No.: US 2026/0338277 A1
(43) Pub. Date: Oct. 29, 2026

(54) MECHANICAL SEAL

(71) Applicant: Global Fluid, LLC, Miami, FL (US)

(72) Inventor: CHRISTIAN LUCHSINGER, Santiago (CL)

(21) Appl. No.: 19/188,331

(22) Filed: Apr. 24, 2025

(51) Int. Cl. F16J 15/34

(52) U.S. Cl. CPC F16J 15/3436

(57) ABSTRACT

The disclosure relates to mechanical seals, such as to mechanical seals used in industrial systems. In some examples, a mechanical seal includes a first casing portion coupled to a second casing portion to form a casing. The mechanical seal also includes a first flange portion coupled to a second flange portion to form a stationary flange ring. In addition, the mechanical seal includes a first rotating drive portion coupled to a second rotating drive portion to form a rotating driving ring. Further, the mechanical seal includes a first rotating drive portion coupled to a second rotating drive portion to form a rotating driving ring. The mechanical seal can be removed from a shaft by removing the various portions from each other.

### TECHNICAL FIELD

The disclosure relates generally to mechanical seals and, more particularly, to mechanical seals used in industrial machines with rotating equipment, such as pumps, compressors, turbines, and reactors.

### BACKGROUND

Mechanical seals are commonly used to prevent the leakage of fluids between an equipment's rotating and stationary elements. For example, a mechanical seal can be used to seal gaps between a rotating shaft and stationary housing of an industrial machine. After extended use, however, mechanical seals can wear down and begin to allow leakage. The mechanical seals must then be replaced, which can be costly. For example, when a mechanical seal malfunctions, the industrial machine may be shut down and disassembled to allow for the replacement of the mechanical seal. The loss of production time and replacement of the mechanical seal can be costly in time and money and, for instance, can delay project completion. As such, there are opportunities to address deficiencies with mechanical seals.

### SUMMARY

In some embodiments, a mechanical seal includes a first casing portion configured to couple to a second casing portion to form a casing. The mechanical seal also includes a first flange portion configured to couple to a second flange portion to form a stationary flange ring. In addition, the mechanical seal includes a first rotating drive portion configured to couple to a second rotating drive portion to form a rotating driving ring. Further, the first casing portion is coupled to the first flange portion and the first rotating drive portion.

In some embodiments, a mechanical seal includes a first casing portion coupled to a second casing portion to form a casing. The mechanical seal also includes a first flange portion coupled to a second flange portion to form a stationary flange ring. In addition, the mechanical seal includes a first rotating drive portion coupled to a second rotating drive portion to form a rotating driving ring. Further, the first casing portion is coupled to the first flange portion and the first rotating drive portion. Moreover, the second casing portion is coupled to the second flange portion and the second rotating drive portion.

In some embodiments, a mechanical seal includes a first casing portion coupled to a second casing portion to form a casing. The mechanical seal also includes a first flange portion coupled to a second flange portion to form a stationary flange ring. In addition, the mechanical seal includes a first rotating drive portion coupled to a second rotating drive portion to form a rotating driving ring. Further, the mechanical seal includes a rotating interface ring coupled to the rotating driving ring, and a stationary interface ring coupled to the stationary flange ring. The mechanical seal further includes a rotating levelling ring coupled to the rotating driving ring, and a stationary levelling ring coupled to the stationary interface ring.

In some embodiments, a system includes a shaft and a mechanical seal coupled to the shaft. The mechanical seal includes a first casing portion coupled to a second casing portion to form a casing. The mechanical seal also includes a first flange portion coupled to a second flange portion to form a stationary flange ring. Further, the mechanical seal includes a first rotating drive portion coupled to a second rotating drive portion to form a rotating driving ring. In addition, the first casing portion is coupled to the first flange portion and the first rotating drive portion. Moreover, the second casing portion is coupled to the second flange portion and the second rotating drive portion.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description.

FIG. 1 illustrates an industrial machine, in accordance with some embodiments described herein;

FIG. 2 illustrates a sectional view of a mechanical seal, in accordance with some embodiments described herein;

FIG. 3A illustrates a perspective view of a mechanical seal, in accordance with some embodiments described herein;

FIG. 3B illustrates a front view of a mechanical seal, in accordance with some embodiments described herein;

FIG. 4A illustrates a sectional view of a mechanical seal, in accordance with some embodiments described herein;

FIG. 4B illustrates portions of a mechanical seal, in accordance with some embodiments described herein;

FIG. 4C illustrates portions of a mechanical seal, in accordance with some embodiments described herein;

FIG. 5A illustrates portions of a mechanical seal, in accordance with some embodiments described herein;

FIG. 5B illustrates portions of a mechanical seal, in accordance with some embodiments described herein;

FIG. 6A illustrates portions of a mechanical seal, in accordance with some embodiments described herein;

FIG. 6B illustrates portions of a mechanical seal, in accordance with some embodiments described herein;

FIG. 7A illustrates portions of a mechanical seal, in accordance with some embodiments described herein;

FIG. 7B illustrates portions of a mechanical seal, in accordance with some embodiments described herein;

FIG. 8A illustrates portions of a mechanical seal, in accordance with some embodiments described herein;

FIG. 8B illustrates portions of a mechanical seal, in accordance with some embodiments described herein;

FIG. 9 illustrates portions of a mechanical seal, in accordance with some embodiments described herein;

FIG. 10 illustrates a pin for a mechanical seal, in accordance with some embodiments described herein; and

FIG. 11 illustrates a clip for a mechanical seal, in accordance with some embodiments described herein.

### DETAILED DESCRIPTION

The following discussion omits or only briefly describes conventional features of mechanical seals and mechanical seal systems that are apparent to those skilled in the art. It is noted that various embodiments are described in detail with reference to the drawings, in which like reference numerals represent like parts and assemblies throughout the several views. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations, permutations, and embodiments.

Unless otherwise specifically defined herein, all terms are to be given their broadest reasonable interpretation including meanings implied from the specification as well as meanings understood by those skilled in the art and/or as defined in dictionaries, treatises, etc. It must also be noted that, as used in the specification and the appended claims, the singular forms “a,” “an” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “above” versus “below,” “inwardly” versus “outwardly,” “longitudinal” versus “lateral,” and the like are to be interpreted relative to one another or relative to an axis of elongation, or an axis or center of rotation, as appropriate. Terms concerning attachments, coupling, and the like, such as “connected” and “interconnected,” refer to a relationship wherein structures are secured or attached to one another either directly or indirectly through intervening structures, as well as both movable or rigid attachments or relationships, unless expressly described otherwise. The terms “operatively connected,” “operably connected,” and the like are such attachments, couplings, or connections that allow the pertinent structures to operate as intended by virtue of that relationship.

Embodiments of the present disclosure relate generally to mechanical seals, such as mechanical seals used to prevent the leakage of fluids in various machines where rotating elements of equipment interface with stationary elements of equipment. When conventional mechanical seals fail and have to be replaced, often times machines (e.g., pumps) must be shut down and disassembled to allow for replacement of the mechanical seal. To remove the mechanical seals, in many instances other portions of the machine must first be removed to allow access to the mechanical seal. Once access to the mechanical seal is obtained, the mechanical seal may then need to be removed from a shaft in a piecemeal fashion. These replacement procedures incur costs as the machines are not productive until the mechanical seal is replaced.

In contrast, the mechanical seals described herein can be removed, for example, directly from a shaft and in a reduced amount of time (e.g., without having to dismantle other equipment to reach the mechanical seal). For example, the mechanical seals can include various parts that are assembled in portions (e.g., halves), where each part can be dismantled by decoupling one portion (e.g., a half) from another. By decoupling one portion of a part from the other, that part can be removed without having to slide the mechanical seal off of the shaft.

In some embodiments, for instance, as further described herein a mechanical seal includes a casing, a stationary flange ring, a rotating driving ring, a rotating interface ring, a stationary interface ring, a rotating levelling ring, and a stationary levelling ring. Each of the casing, stationary flange ring, and rotating driving ring are assembled in halves, such that each of these parts can be removed from a shaft by decoupling one half from another. In other words, to remove the mechanical seal from a shaft, for each part a half is decoupled from its partner half. Similarly, to replace the mechanical seal, a half of each part is coupled to its partner half around the shaft, until all parts are secured.

In some embodiments, a mechanical seal includes a casing, a stationary flange ring, a rotating driving ring, a rotating interface ring, a stationary interface ring, a rotating levelling ring, and a stationary levelling ring. Each of the casing, stationary flange ring, rotating driving ring, rotating interface ring, stationary interface ring, rotating levelling ring, and stationary levelling ring are assembled in halves, such that each of these parts can be removed from a shaft by decoupling one half from another.

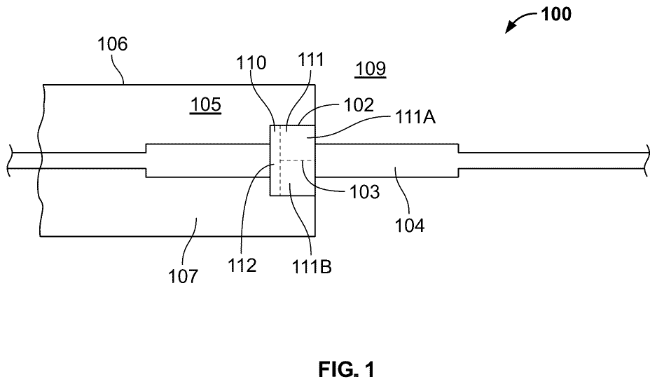

Referring now to the drawings, FIG. 1 illustrates a rotating system 100 (e.g., a pump system) that includes a mechanical seal 102 mounted on a shaft 104 (e.g., axis) within a housing 106. The mechanical seal 102 can prevent fluid 105 from escaping from an interior 107 of the housing 106 to the external environment 109. The mechanical seal can include various parts including one or more parts 110, and one or more parts 111. Parts 110 can include, for example, a rotating driving ring, while parts 111 can include a casing, a stationary flange ring, a rotating interface ring, a stationary interface ring, a rotating levelling ring, and a stationary levelling ring. Parts 111 can be disassembled along interface 103 by decoupling portions 111A from portions 111B along interface 103, thereby allowing for the removal of parts 111 from the shaft 104 without having to slide parts 111 off of the shaft 104.

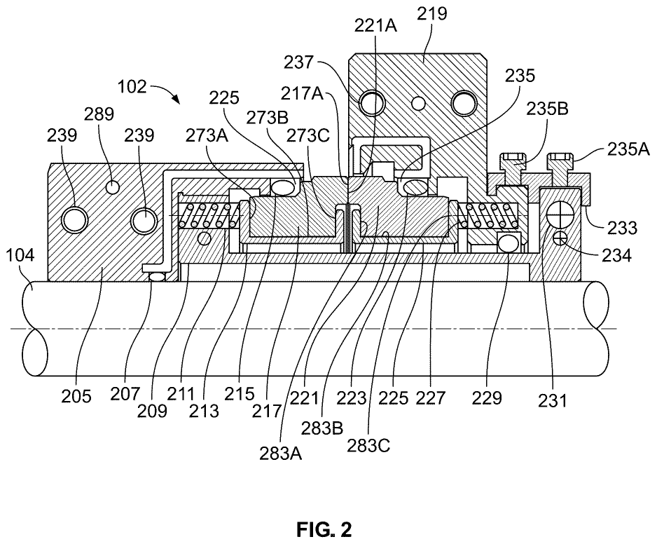

FIG. 2 illustrates a sectional view of an example of the mechanical seal 102 mounted to the shaft 104. In this example, the mechanical seal 102 includes a rotating driving ring 205, a stationary flange ring 219, a rotating interface ring 217, a stationary interface ring 221, a casing 209, a rotating leveling ring 213, and a stationary leveling ring 225. As illustrated, the shaft 104 proceeds through each of these parts. In addition, as will be understood, when the shaft 104 rotates, so do the rotating driving ring 205, rotating interface ring 217, and rotating leveling ring 213.

The mechanical seal 102 also includes multiple O-rings (e.g., gaskets) including a driving O-ring 207, a rotating interface O-ring 215, a stationary interface O-ring 223, and a casing O-ring 229. Further, the mechanical seal 102 includes driving ring cavities 239, pin cavities 289, rotating-side springs 211, stationary-side springs 227, stationary ring cavities 237, a casing flange cavity 231, a casing pin cavity 234, a clip 233, and clip fasteners 235A, 235B,

In some examples, one or more of the rotating driving ring 205, stationary flange ring 219, rotating interface ring 217, stationary interface ring 221, casing 209, rotating leveling ring 213, stationary leveling ring 225, rotating-side springs 211, and stationary-side springs 227 are made of a metal, metal alloy, or any other suitable material. In some examples, the rotating interface ring 217, stationary interface ring 221, or at least their opposing faces 217A, 221A thereof, are made of ceramic, metal, or metal alloy. As the rotating ring 217 rotates, its face 217A is in contact with (e.g., and seals against) the face 221A of the stationary interface ring 221. In some examples, one or more of the driving O-ring 207, rotating interface O-ring 215, stationary interface O-ring 223, and casing O-ring 229 are made of elastomers, or any other suitable material.

As illustrated, the rotating driving ring 205 can provide a spring force (i.e., clamping force) to the rotating levelling ring 213 via the rotating-side springs 211. Similarly, the stationary flange ring 219 can provide a spring force (i.e., clamping force) to the stationary levelling ring 225 via the stationary-side springs 227. In addition, the first clip fastener 235A secures the clip 233 to the casing 209, while the second clip fastener 235B secures the clip 233 to the stationary flange ring 219. In this manner, the clip 233 secures the casing 209 to the stationary flange ring 219.

Furthermore, the rotating driving ring 205 secures the rotating interface ring 217 to the rotating level ring 213, where the rotating interface O-ring 215 is secured in a cavity 225 that is formed between the rotating interface ring 217 and the rotating level ring 213. Further, the rotating interface ring 217 is positioned within a cavity of the rotating level ring 213, where the rotating interface ring 217 contacts the rotating level ring 213 on three interior surfaces 273A, 273B, 273C.

Similarly, the stationary flange ring 219 secures the stationary interface ring 221 to the stationary level ring 225, where the stationary interface O-ring 223 is secured in a cavity 235 that is formed between stationary interface ring 221 and the stationary level ring 225. Further, the stationary interface ring 221 is positioned within a cavity of the stationary level ring 225, where the stationary interface ring 221 contacts the stationary level ring 225 on three interior surfaces 283A, 283B, 283C.

Each of the driving ring cavities 239, stationary ring cavities 237, and casing flange cavity 231 are configured to receive a fastener, such as a flange. For example, and as described further herein, the driving ring cavities 239 can receive corresponding flanges from another portion (e.g., another half) of the rotating driving ring 205 to form the rotating driving ring 205. Likewise, the stationary ring cavities 237 can receive corresponding flanges from another portion of the stationary flange ring 219 to form the stationary flange ring 219. The pin cavities 289 are configured to receive a pin, such as the pins described herein, to secure one portion of the rotating driving ring 205 to another.

The face 217A of the rotating interface ring 217 forms a hydrodynamic seal with the face 221A of the stationary interface ring 221, thereby preventing leakage during operation. For example, during operation, the shaft 104 rotates, causing the rotating driving ring 205 to rotate, which causes the rotating leveling ring 213 and rotating interface ring 217 to also rotate. The stationary flange ring 219, which may be secured to stationary housing, for instance, is stationary. Thus, the stationary interface ring 221 does not rotate, although its face 221A forms the hydrodynamic seal with the face 217A of the rotating interface ring 217.

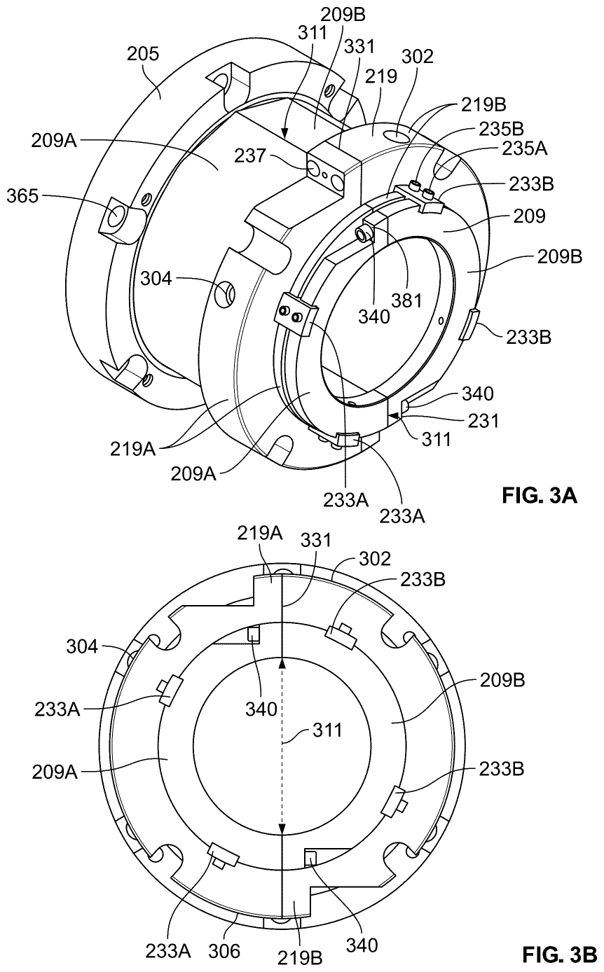

FIGS. 3A and 3B illustrate further details of portions of the mechanical seal 102. As illustrated, the casing 209 includes a first casing portion 209A and a second casing portion 209B that meet at interface 311. The first casing portion 209A can be secured to the second casing portion 209B by inserting fasteners 340 (e.g., flanges) into casing flange openings 381 that align with opposing casing flange cavities 231. Moreover, the clips 233A can secure the first casing portion 209A to a first flange portion 219A of the stationary flange ring 219, while the clips 233B can secure the second casing portion 209B to a second flange portion 219B of the stationary flange ring 219. The first flange portion 219A meets the second flange portion 219B at interface 331 to form the stationary flange ring 219.

As further illustrated, the first flange portion 219A of the stationary flange ring 219 includes a flush 304 (e.g., to introduce a liquid to cool and lubricate the seal formed by the faces 217A, 221A) and a quench 306 (e.g., to introduce a liquid to cool or clean the seal), while the second flange portion 219B of the stationary flange ring 219 includes a drain 302 (e.g., to allow for fluid exit). In addition, the rotating driving ring 205 includes spring cavities 365 to secure the rotation side springs 211.

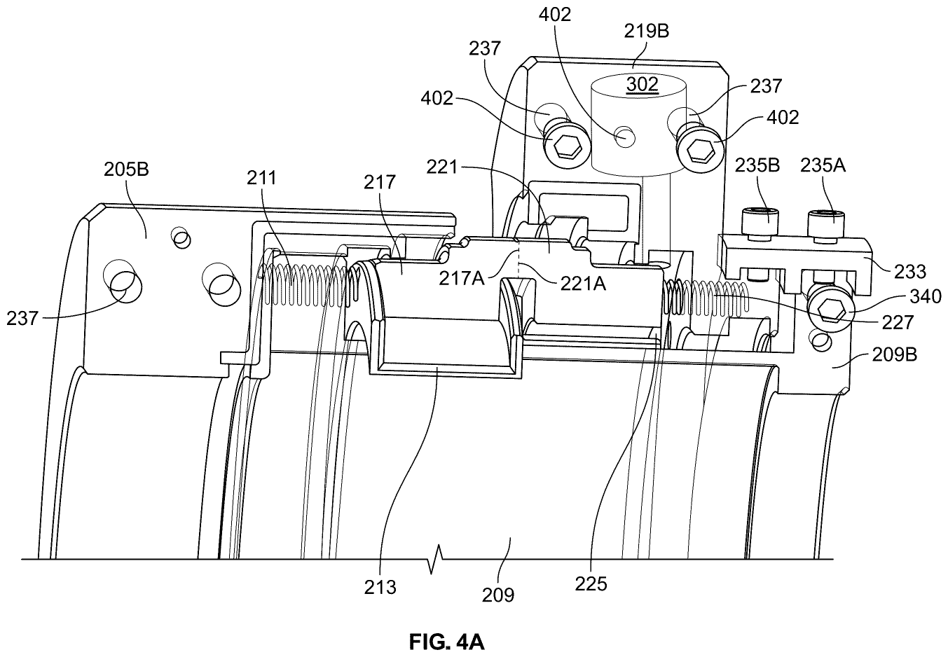

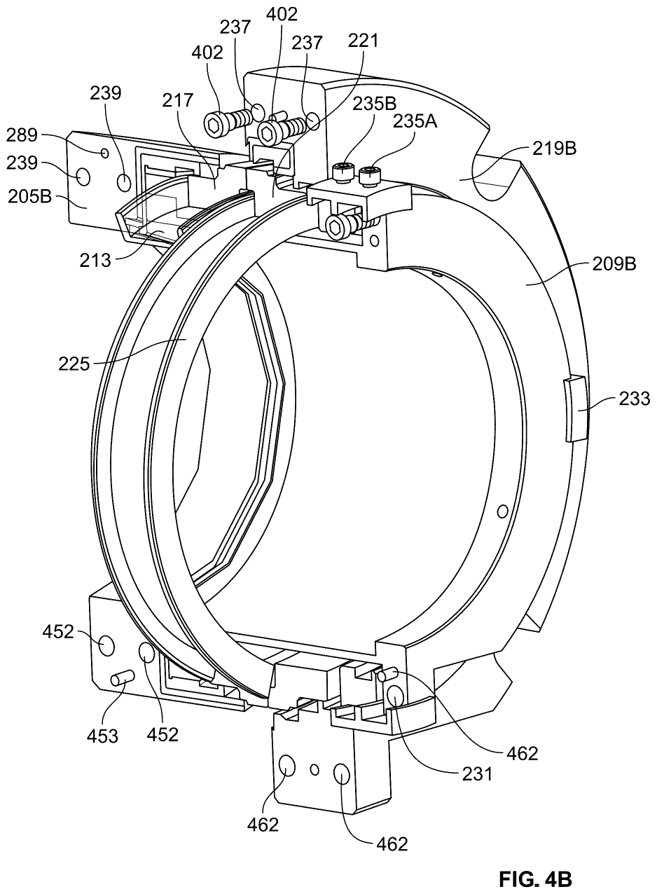

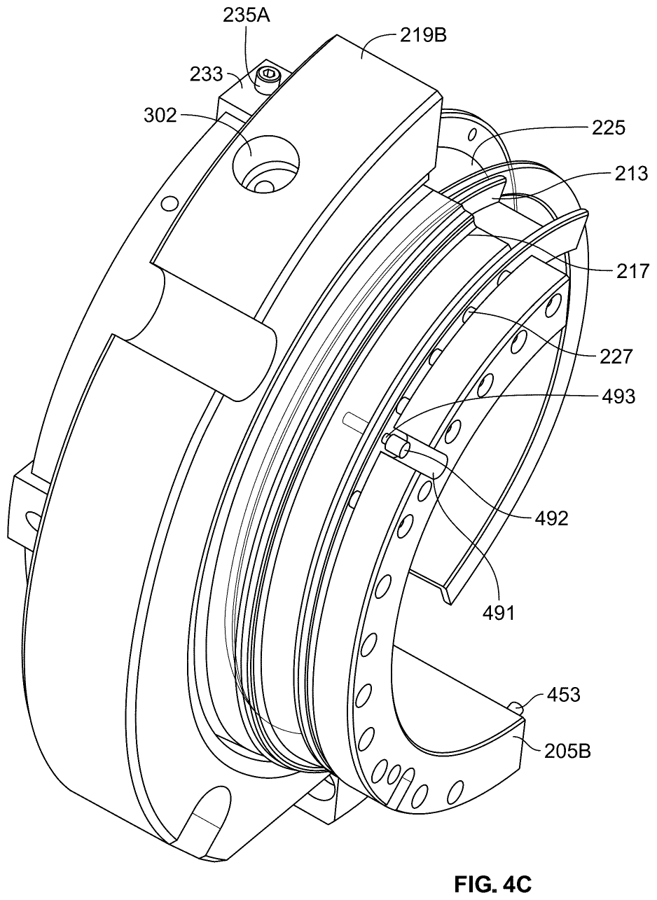

FIGS. 4A, 4B and 4C illustrate further views of one portion of the mechanical seal 102. For example, a second rotating drive portion 205B of the rotating driving ring 205 provides a spring force (i.e., clamping force) to the rotating levelling ring 213 via the rotating-side springs 211. Similarly, the second flange portion 219B of the stationary flange ring 219 can provide a spring force (i.e., clamping force) to the stationary levelling ring 225 via the stationary-side springs 227. In addition, the first clip fastener 235A secures the clip 233 to the second casing portion 209B of the casing 209, while the second clip fastener 235B secures the clip 233 to the second flange portion 219B of the stationary flange ring 219. In this example, fasteners 402 (e.g., flanges) are inserted into the stationary ring cavities 237.

As illustrated in FIG. 4B, the second flange portion 219B of the stationary flange ring 219 further includes cavities 462 to allow for coupling to the first flange portion 219A of the stationary flange ring 219 using, for instance, fasteners (e.g., flanges). In addition, the second rotating drive portion 205B of the rotating driving ring 205 includes cavities 452 to allow for coupling to the first rotating drive portion 205A of the rotating driving ring 205 using, for instance, fasteners (e.g., flanges). The second rotating drive portion 205B also includes a pin 453 that can be inserted into a corresponding cavity of the first rotating drive portion 205A, further securing the first rotating drive portion 205A to the second rotating drive portion 205B to form the rotating driving ring 205. Further still, the second casing portion 209B of the casing 209 includes a pin 462 that can be inserted into a corresponding cavity of the first casing portion 209A, further securing the first casing portion 209A to the second casing portion 209B to form the casing 209.

As FIG. 4C illustrates, the second rotating drive portion 205B also includes cavities 491 that allow for insertion of pins 492 through corresponding pin openings 493 of the rotating leveling ring 213 and rotating interface ring 217 to secure the second rotating drive portion 205B.

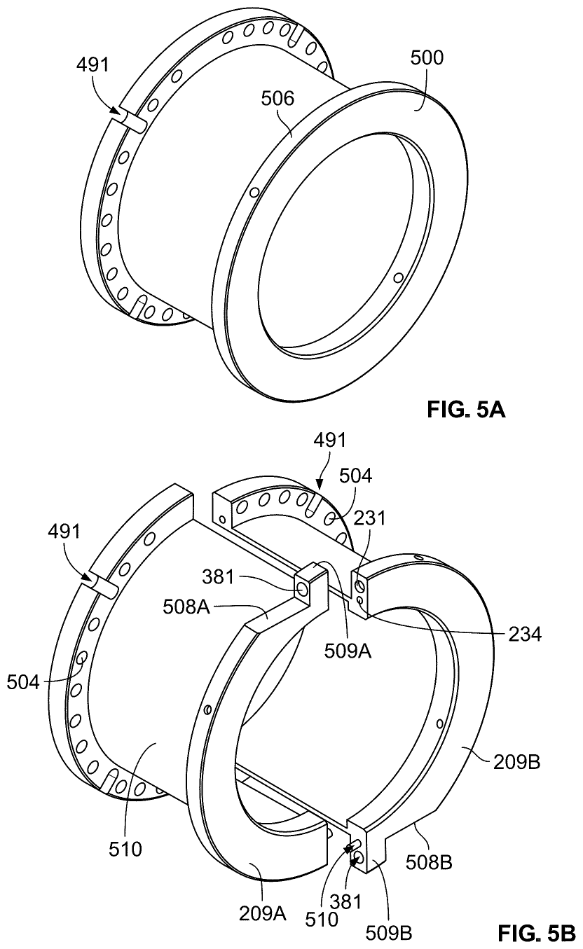

FIG. 5A illustrates a casing 500 before final manufacturing, while FIG. 5B shows the casing 209 after manufacturing. For instance, to arrive at the final casing 209 of FIG. 5B, the casing 500 of FIG. 5A is cut (e.g., in half) to form first casing portion 209A and second casing portion 209B. Moreover, a cylindrical rim 506 is cut to form surfaces 508A, 508B, thereby defining protrusions 509A, 509B. Each protrusion 509A, 509B further includes a pin 510 that can be inserted into a corresponding and opposing casing pin cavity 234 to assemble the casing 209. In addition, flange openings 381A, 381B are bored from the protrusions 509A, 509B, respectively, which align with corresponding, and opposing casing flange cavities 231. As described herein, a fastener, such as a flange, can be inserted through the flange openings 381A, 381B and into the corresponding and opposing casing flange cavities 231 to further secure the first casing portion 209A to the second casing portion 209B.

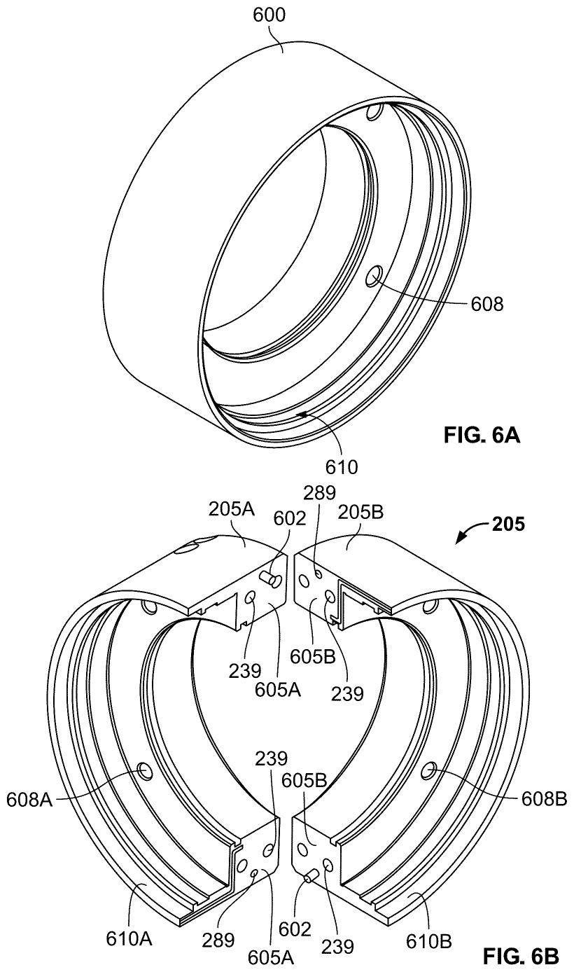

FIG. 6A illustrates a rotating driving ring 600 before final manufacturing, while FIG. 6B shows the rotating driving ring 205 after manufacturing. For instance, to arrive at the rotating driving ring 205, the rotating driving ring 600 is cut (e.g., in half) to form the first rotating drive portion 205A and the second rotating drive portion 205B. In addition, the driving ring cavities 239 are bored from the surfaces 605A, 605B, wherein the driving ring cavities 239 for the first rotating drive portion 205A are aligned with the driving ring cavities 239 of the second rotating drive portion 205B.

Furthermore, pin cavities 289 are also bored from the surfaces 605A, 605B, and a pin 602 is inserted into a pin cavity 289 of one of each of surfaces 605A, 605B. For example, one pin 602 is inserted into the top surface 605A of the first rotating drive portion 205A, and one pin 602 is inserted into a bottom surface 605B of the second rotating drive portion 205B. As described herein, when forming the rotating driving ring 205 by combining the first rotating drive portion 205A and second rotating drive portion 205B, each pin 602 is inserted into the corresponding and opposing pin cavity 289. Fasteners, such as flanges, can be inserted through the openings 608 to secure the rotating driving ring 205 to the casing 209. For instance, fasteners can be inserted through openings 608A of the first rotating drive portion 205A and into one of the cavities 463 of the first casing portion 209A to secure the first rotating drive portion 205A to the first casing portion 209A. Similarly, fasteners can be inserted through openings 608B of the second rotating drive portion 205B and into one of the cavities 463 of the second casing portion 209B to secure the second rotating drive portion 205B to the second casing portion 209B.

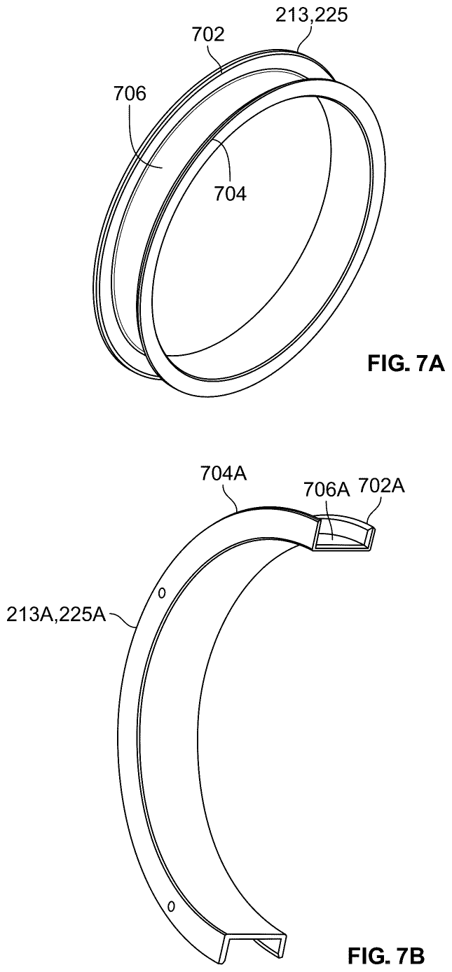

FIG. 7A illustrates an example of a rotating leveling ring 213 and stationary leveling ring 225 (referred to herein as “the rings 213, 225”). As illustrated, the rings 213, 225 include a first cylindrical rim 702 opposite a second cylindrical rim 704, with a cylindrical surface 706 defined between the first cylindrical rim 702 and second cylindrical rim 706. In some examples, the rings 213, 225 can be cut (e.g., in half) to form corresponding portions. FIG. 7B, for example, illustrates a first ring portion 213A, 225A, which can be half of the original rings 213, 225. In other words, the first ring portion 213A can be combined with a second ring portion 213A to form the rotating leveling ring 213. Similarly, the first ring portion 225A can be combined with a second ring portion 225A to form the stationary leveling ring 225.

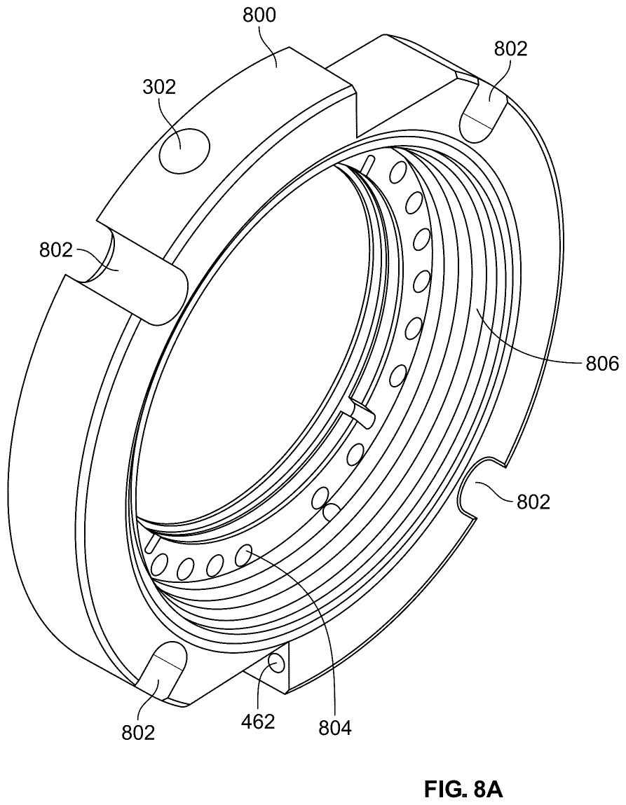

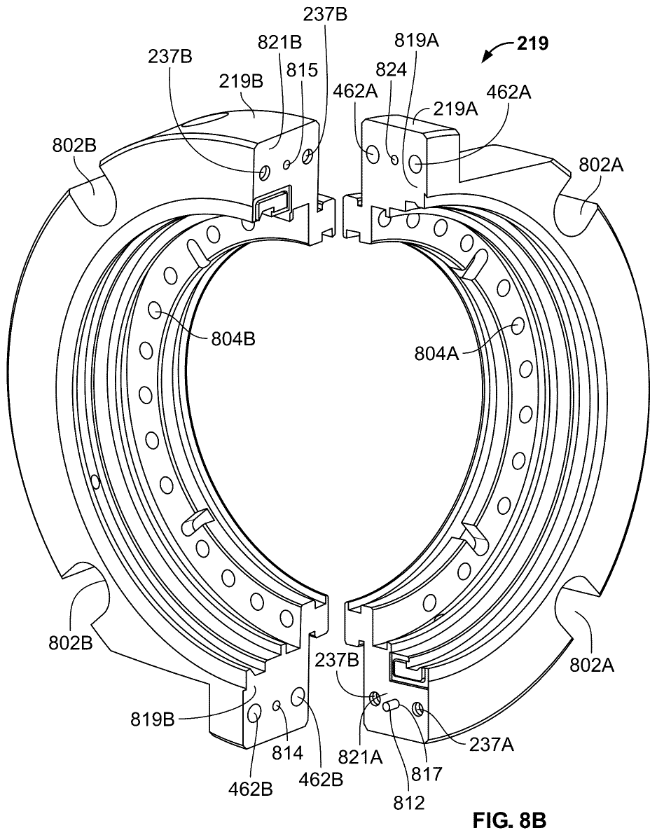

FIG. 8A illustrates an example of a stationary flange ring 800 before final manufacturing, while FIG. 8B illustrates the stationary flange ring 219 after manufacturing. As illustrated in FIG. 8A, the stationary flange ring 800 includes channel cutouts 802, and openings 804. To arrive at the stationary flange ring 219 illustrated in FIG. 8B, the stationary flange ring 800 is cut (e.g., in half) to form the first flange portion 219A and the second flange portion 219B. As a result, the first flange portion 219A includes channel cutouts 802A and openings 804A, while the second flange portion 219B includes channel cutouts 802B and openings 804B. The openings 804A, 804B can allow for the placement of springs, such as the stationary-side springs 227.

In addition, cavities 462A and cavity 824 are bored into the surface 819A of the first flange portion 219A, while cavities 462B and cavity 814 are bored into the surface 819B of the second flange portion 219B. Moreover, cavities 237A and cavity 817 are bored into the surface 821A of the first flange portion 219A, while cavities 237B and cavity 815 are bored into the surface 821B of the second flange portion 219B. In some examples, a pin 812 is inserted into at least one cavity 817, 824 of the first flange portion 219A. Because the corresponding cavities 814, 815 of the second flange portion 219B, respectively, are aligned, the pin 812 inserts into the corresponding and opposite cavity 814, 815 of the second flange portion 219B when the first flange portion 219A is coupled to the second flange portion 219B. In some examples, one end of a first pin 812 is inserted into cavity 817, and the other end of the first pin 821 is inserted into the cavity 814. Additionally or alternatively, one end of a second pin 812 is inserted into cavity 824, and the other end of the second pin 821 is inserted into the cavity 815.

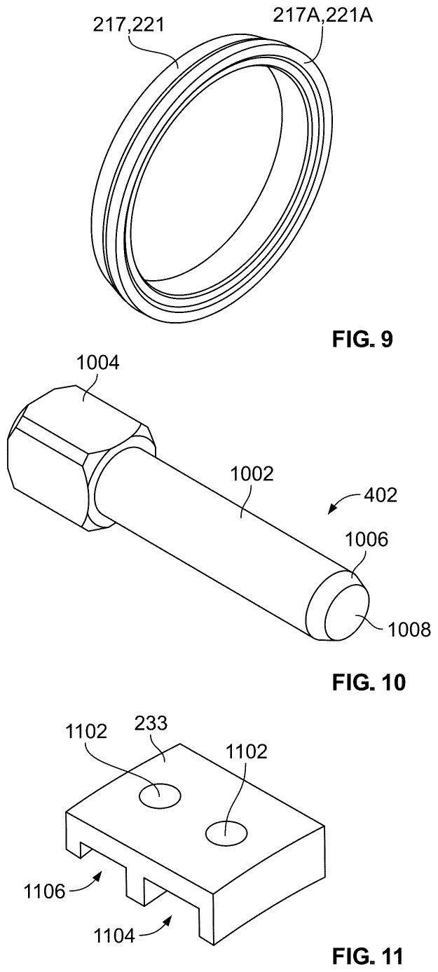

FIG. 9 illustrates an example of a rotating interface ring 217 and stationary interface ring 221 (referred to herein as “the interface rings 217, 221”). As illustrated, the interface rings 217, 221 have a sealing surface 217A, 221A that forms a seal with a corresponding one of the interface rings 217, 221, as described further herein.

FIG. 10 illustrate an example of a fastener, such as fastener 402. As illustrated, The fastener 402 includes a rectangular head portion 1004, and a stem portion 1002 that includes a beveled surface 1006 that ends in a flat surface 1008.

FIG. 11 illustrates an example of the clip 233. As illustrated, the clip 233 includes two openings 1102. As described further herein, clip fasteners 235A, 235B can be inserted through the openings 1102 to secure the clip 233 to the casing 209 and stationary flange ring 219, respectively. Moreover, the clip 233 includes channels 1104, 1106, which allow the clip 233 to be placed over corresponding portions (e.g., raised portions) of the casing 209 and stationary flange ring 219 (e.g., using a snug fit in each channel). For instance, the casing 209 and stationary flange ring 219 include raised portions that fit into the channels 1104, 1106 of the clip 233, respectively.

The following is a list of non-limiting illustrative embodiments disclosed herein:

1. A mechanical seal, comprising:
a first casing portion configured to couple to a second casing portion to form a casing;
a first flange portion configured to couple to a second flange portion to form a stationary flange ring; and
a first rotating drive portion configured to couple to a second rotating drive portion to form a rotating driving ring, wherein the first casing portion is coupled to the first flange portion and the first rotating drive portion.

2. The mechanical seal of illustrative embodiment 1, further comprising a first rotating ring portion of a rotating interface ring configured to couple to the first rotating drive portion.

3. The mechanical seal of illustrative embodiment 2, further comprising a first rotating levelling ring portion of a rotating levelling ring configured to couple to the first rotating ring portion.

4. The mechanical seal of illustrative embodiment 3 comprising at least one spring coupled to the first rotating levelling ring portion and the first rotating drive portion.

5. The mechanical seal of any of illustrative embodiments 1-4, further comprising a first stationary ring portion of a stationary interface ring configured to couple to the first flange portion.

6. The mechanical seal of illustrative embodiment 5, further comprising a first stationary levelling ring portion of a stationary levelling ring configured to couple to the first stationary ring portion.

7. The mechanical seal of illustrative embodiment 6 comprising at least one spring coupled to the first stationary levelling ring portion and the first flange portion.

8. A mechanical seal, comprising:
a first casing portion coupled to a second casing portion to form a casing;
a first flange portion coupled to a second flange portion to form a stationary flange ring; and
a first rotating drive portion coupled to a second rotating drive portion to form a rotating driving ring.

9. The mechanical seal of illustrative embodiment 8, further comprising a rotating interface ring comprising a first rotating ring portion coupled to a second rotating ring portion, wherein the first rotating ring portion is coupled to the first rotating drive portion, and the second rotating ring portion is coupled to the second rotating drive portion.

10. The mechanical seal of illustrative embodiment 9, further comprising a rotating levelling ring comprising a first rotating levelling ring portion and a second rotating levelling ring portion, wherein the first rotating levelling ring portion is coupled to the first rotating ring portion and the second rotating levelling ring portion is coupled to the second rotating ring portion.

11. The mechanical seal of illustrative embodiment 10, further comprising at least one spring coupled to the first rotating levelling ring portion and the first rotating drive portion.

12. The mechanical seal of any of illustrative embodiments 8-11, further comprising a stationary interface ring comprising a first stationary ring portion coupled to a second stationary ring portion, wherein the first stationary ring portion is coupled to the first flange portion, and the second stationary ring portion is coupled to the second flange portion.

13. The mechanical seal of illustrative embodiment 12, further comprising a stationary levelling ring comprising a first stationary levelling ring portion and a second stationary levelling ring portion, wherein the first stationary levelling ring portion is coupled to the first stationary ring portion and the second stationary levelling ring portion is coupled to the second stationary ring portion.

14. The mechanical seal of illustrative embodiment 13, further comprising at least one spring coupled to the first stationary levelling ring portion and the first flange portion.

15. The mechanical seal of any of illustrative embodiments 8-14 comprising a first clip configured to secure the first casing portion to the first flange portion, and a second clip configured to secure the second casing portion to the second flange portion.

16. A system, comprising:
a shaft; and
a mechanical seal coupled to the shaft and comprising:
   a first casing portion coupled to a second casing portion to form a casing;
   a first flange portion coupled to a second flange portion to form a stationary flange ring; and
   a first rotating drive portion coupled to a second rotating drive portion to form a rotating driving ring.

17. The system of illustrative embodiment 16, wherein the mechanical seal further comprises a rotating interface ring comprising a first rotating ring portion coupled to a second rotating ring portion, wherein the first rotating ring portion is coupled to the first rotating drive portion, and the second rotating ring portion is coupled to the second rotating drive portion.

18. The system of illustrative embodiment 17, wherein the mechanical seal further comprises a rotating levelling ring comprising a first rotating levelling ring portion and a second rotating levelling ring portion, wherein the first rotating levelling ring portion is coupled to the first rotating ring portion and the second rotating levelling ring portion is coupled to the second rotating ring portion.

19. The system of illustrative embodiment 18, wherein the mechanical seal further comprises at least one spring coupled to the first rotating levelling ring portion and the first rotating drive portion.

20. The system of any of illustrative embodiments 16-19, wherein the mechanical seal further comprises a stationary interface ring comprising a first stationary ring portion coupled to a second stationary ring portion, wherein the first stationary ring portion is coupled to the first flange portion, and the second stationary ring portion is coupled to the second flange portion.

The various embodiments described above are provided by way of illustration only and should not be construed to limit the claims attached hereto. Those skilled in the art will readily recognize various modifications and changes that may be made without following the example embodiments and applications illustrated and described herein, and without departing from the spirit and scope of the following claims.

1. A mechanical seal, comprising:
a casing formed from a first casing portion coupled to a second casing portion;
a stationary flange ring formed from a first flange portion coupled to a second flange portion, the stationary flange ring coupled to the casing;
a stationary leveling ring formed from a first stationary leveling portion and a second stationary leveling portion, the stationary leveling ring coupled to the casing;
a stationary interface ring formed from a first stationary interface portion and a second stationary interface portion, the stationary interface ring positioned in the stationary leveling ring;
a rotating driving ring formed from a first rotating driving portion coupled to a second rotating driving portion;
a rotating leveling ring formed from a first rotating leveling portion coupled to a second rotating leveling portion, the rotating leveling ring positioned in the casing adjacent to the stationary leveling ring;
a rotating interface ring formed from a first rotating interface portion and a second rotating interface portion, the rotating interface ring positioned in the rotating leveling ring,
wherein a face of the stationary interface ring and a face of the rotating interface ring form a seal therebetween.

2.-6. (canceled)

7. The mechanical seal of claim 1, comprising at least one spring contacting the stationary leveling ring to bias the stationary interface ring in a direction toward the rotating interface ring.

8. A mechanical seal, comprising:
a casing;
a stationary flange ring coupled to the casing;
a stationary leveling ring positioned in the casing;
a stationary interface ring positioned in the stationary leveling ring;
a rotating driving ring coupled to the casing;
a rotating leveling ring positioned in the casing;
a rotating interface ring positioned in the rotating leveling ring,
wherein a face of the stationary interface ring and a face of the rotating interface ring form a seal therebetween.

9. (canceled)

10. (canceled)

11. The mechanical seal of claim 8, further comprising at least one spring contacting the stationary leveling ring to bias the stationary interface ring in a direction toward the rotating interface ring.

12. (canceled)

13. (canceled)

14. The mechanical seal of claim 11, further comprising at least one spring contacting the rotating leveling ring to bias the rotating interface ring in a direction toward the stationary interface ring.

15. The mechanical seal of claim 8 comprising at least one clip connecting the casing to the stationary flange ring.

16. A system, comprising:
a shaft; and
the mechanical seal of claim 8.

17.-20. (canceled)

21. The mechanical seal of claim 1, further comprising at least one spring contacting the rotating leveling ring to bias the rotating interface ring in a direction toward the stationary interface ring.

22. The mechanical seal of claim 1, further comprising at least one clip connecting the casing to the stationary flange ring.

23. The mechanical seal of claim 1, wherein the rotating leveling ring comprises a U-shape formed by a first rim and a second rim separated by a cylindrical portion.

24. The mechanical seal of claim 23, wherein the rotating interface ring is positioned inside the rotating leveling ring between the first rim and the second rim.

25. The mechanical seal of claim 1, wherein the stationary leveling ring comprises a U-shape formed by a first rim and a second rim separated by a cylindrical portion.

26. The mechanical seal of claim 25, wherein the stationary interface ring is positioned inside the rotating leveling ring between the first rim and the second rim.

27. The mechanical seal of claim 8, wherein the rotating leveling ring comprises a U-shape formed by a first rim and a second rim separated by a cylindrical portion.

28. The mechanical seal of claim 27, wherein the rotating interface ring is positioned inside the rotating leveling ring between the first rim and the second rim.

29. The mechanical seal of claim 8, wherein the stationary leveling ring comprises a U-shape formed by a first rim and a second rim separated by a cylindrical portion.

30. The mechanical seal of claim 29, wherein the stationary interface ring is positioned inside the rotating leveling ring between the first rim and the second rim.
